(19) United States
(12) Patent Application Publication
(10) Pub. No.: US 2026/0348389 A1
(43) Pub. Date: Nov. 5, 2026

(54) AIR COMPRESSOR

(71) Applicant: Hanon Systems, Daejeon (KR)

(72) Inventors: Kyu Sung CHOI, Daejeon (KR); Hyun Chil KIM, Daejeon (KR); Gunwoong PARK, Daejeon (KR); Min Gyu PARK, Daejeon (KR); Jun Hyuk PARK, Daejeon (KR); Chi Yong PARK, Daejeon (KR); Hyun Sup YANG, Daejeon (KR); Jong Sung LEE, Daejeon (KR)

(73) Assignee: Hanon Systems, Daejeon (KR)

(21) Appl. No.: 19/146,469

(22) PCT Filed: Dec. 29, 2023
(86) PCT No.: PCT/KR2023/021984

§ 371 Date: Jul. 8, 2025

(30) Foreign Application Priority Data
Mar. 17, 2023 (KR) 10-2023-0035330

(51) Int. Cl. F04D 25/08; F04D 17/10; F04D 29/051; F04D 29/056; F04D 29/58

(52) U.S. Cl. CPC F04D 25/082; F04D 17/10; F04D 29/051; F04D 29/0563; F04D 29/5806; F04D 29/582

(57) ABSTRACT

The present invention relates to an air compressor configured to deliver compressed air to a fuel cell system, and more particularly, to a technology related to an air compressor in which a part of sucked air is used as cooling air for cooling a bearing and a motor, and a flow path for the cooling air is disposed adjacent to a coolant flow path, thereby improving cooling performance of the cooling air.

### TECHNICAL FIELD

The present invention relates to an air compressor configured to deliver compressed air to a fuel cell system, and more particularly, to a technology related to an air compressor in which a part of sucked air is used as cooling air for cooling a bearing and a motor, and a flow path for the cooling air is disposed adjacent to a coolant flow path, thereby improving cooling performance of the cooling air.

### BACKGROUND ART

A fuel cell electric vehicle refers to a vehicle in which electrical energy, which is generated by an electrochemical reaction that is a reverse reaction of electrolysis of water when hydrogen and oxygen are supplied to a humidifier, is supplied as driving power for the vehicle. Korean Patent No. 10-0962903 discloses a general fuel cell electric vehicle.

Typically, a passenger fuel cell electric vehicle is equipped with a 100 kW fuel cell stack. In case that the fuel cell stack operates under a pressurized condition, air to be supplied to the fuel cell stack is supplied at a high pressure of 1 to 4 bar. To this end, an air compressor with a rotational speed of 100,000 to 200,000 RPM needs to be used.

Typically, a fuel cell electric vehicle includes a fuel cell stack configured to produce electricity, a humidifier configured to increase a humidity of air to be supplied to the fuel cell stack, a fuel supply part configured to supply hydrogen to the fuel cell stack, an air supply part configured to supply air, which contains oxygen, to the fuel cell stack, and a cooling module configured to cool the fuel cell stack.

The air supply part includes an air cleaner configured to filter out foreign substances contained in the air, an air compressor configured to compress and supply the air filtered by the air cleaner, and a control box configured to control the air compressor.

The air compressor compresses the air, which is sucked from the outside, by using an impeller and transfers the air to the fuel cell stack through an exhaust port. In this case, the impeller and a shaft, which constitute a compression part, are operated by a rotational force of a motor.

However, the air compressor in the related art has a problem in that cooling performance is low because a space around a bearing is narrow, and cooling air needs to pass through a narrow gap to cool the bearing, the motor, and the like. In particular, a temperature of a journal bearing positioned rearward of the motor and the air compressor is easily rapidly raised, which sometimes causes damage to the bearing.

In order to solve the problem, a water-cooled cooling flow path is formed in a casing of the motor to cool the bearing and the motor. However, there is a problem in that the cooling structure is insufficient to cool a rear bearing because an interval between the rear bearing and the cooling flow path, in which a coolant is present, is large, and a contact area is small.

In addition, because the cooling flow path mainly serves to exchange heat, which is mostly generated by the motor, with the coolant, there is a problem in that cooling performance of secondary cooling air for cooling a motor shaft and a disc deteriorates because a distance between the secondary cooling air and the cooling flow path is long.

In case that the cooling performance of the secondary cooling air deteriorates, there occurs a problem in that the performance in cooling a thrust bearing provided on the disc and cooling the journal bearing provided on the motor shaft deteriorates, and the durability of the thrust bearing and the journal bearing deteriorates.

### Disclosure

### Technical Problem

The present invention has been made in an effort to solve the above-mentioned problems, and an object of the present invention is to provide an air compressor having a zigzag-type coolant flow path connected to the inside from an outer periphery of a compressor housing.

Another object of the present invention is to provide an air compressor in which a disc is disposed forward of the air compressor to improve aerodynamic efficiency.

Still another object of the present invention is to provide an air compressor in which an upstream side of a secondary cooling air flow path is configured by a front cartridge and a front motor housing so as to pass along a thrust bearing and a front journal bearing that are air bearings, and a downstream side of the secondary cooling air flow path is formed on a rear cartridge so as to pass along a rear journal bearing.

Yet another object of the present invention is to provide an air compressor in which a secondary cooling air flow path and a coolant flow path are disposed closely to improve performance in cooling the secondary cooling air flow path.

### Technical Solution

An air compressor according to an embodiment of the present invention includes: a housing configured to accommodate a motor having a motor shaft, the housing having a coolant flow path formed between a cylindrical inner peripheral surface and an outer peripheral surface so that a coolant flows along the coolant flow path; a front housing coupled to a front side of the housing and configured to support an impeller configured to suck outside air; a front cartridge configured to accommodate a front journal bearing and configured to support a front side of the motor shaft by means of the front journal bearing; a rear cartridge configured to accommodate a rear journal bearing and configured to support a rear side of the motor shaft by means of the rear journal bearing; a rear housing coupled to a rear side of the housing and configured to seal the rear side of the housing; and a cooling air flow path configured to cool the motor shaft or the motor by receiving a part of air introduced from a front side of the impeller and introducing the air into the housing, in which the cooling air flow path includes a cooling air space formed between the front housing and the front cartridge.

In addition, the cooling air flow path may pass along the front journal bearing and the rear journal bearing.

In addition, the cooling air flow path may include: a first flow path formed between the impeller and the front housing to supply a part of the air, which is introduced into the impeller, to the cooling air space; a second flow path formed through the front cartridge to introduce the air in the cooling air space into a motor space in the housing; and a third flow path formed in the housing and configured to allow the second flow path and the motor space to communicate with each other.

In addition, the cooling air space may include: a first space formed radially inside a front surface of the front cartridge; and a second space formed radially outward, the front cartridge may include: a ring-shaped protrusion protruding forward in a circumferential direction from the front surface of the front cartridge to separate the first space and the second space; and a through-groove recessed rearward at a front side end of the ring-shaped protrusion to allow the first space and the second space to communicate with each other, the first space may communicate with the first flow path, and the second space may communicate with the second flow path.

In addition, the cooling air space may include a third space configured to communicate with the first space and formed between the motor shaft and a shaft through-hole penetrated by the motor shaft, and the front journal bearing may be provided in the third space so that the front journal bearing is cooled by the air.

In addition, a radially outer side of the cooling air space may be sealed by an O-ring provided between the front housing and a radially outer side of the front cartridge.

In addition, the through-groove may be provided as a plurality of through-grooves disposed to be spaced apart from one another in a circumferential direction of the ring-shaped protrusion, the second flow path may be provided as a plurality of second flow paths disposed to be radially spaced apart from one another in a circumferential direction of the front cartridge, and the second flow path may be disposed on a radially outward extension line of the through-groove.

In addition, the air compressor may include a disc provided on the motor shaft, and the disc may be disposed between the front housing and the front cartridge.

In addition, a front side of the disc may be rotatably supported by a front thrust bearing provided between the disc and the front housing, a rear side of the disc may be rotatably supported by a rear thrust bearing provided between the disc and the front cartridge, and cooling air introduced into the first flow path may be introduced into the cooling air space via the front thrust bearing and the rear thrust bearing to cool the front thrust bearing and the rear thrust bearing.

In addition, a pin groove may be formed in the first space so that a pin P, which has a front end fixed to the front housing and the other end fixed to the front cartridge, is inserted into the pin groove, and the pin groove may be provided as a plurality of pin grooves radially formed in a circumferential direction of the front cartridge.

In addition, the cooling air flow path may include a first path and a second path, the first path may pass along the first flow path, the first and second spaces, the second and third flow paths, the motor space, the motor, and a fourth flow path formed through the rear cartridge, and the second path may pass along the first flow path, the front thrust bearing, the first space, the rear thrust bearing, the third space, the front journal bearing, a fourth space between an outer peripheral surface of the motor shaft and the motor, and the rear journal bearing.

In addition, the air passing through the first path or the second path may circulate to a front side of the air compressor through a cooling air circulation flow path having a front end configured to communicate with a space between the rear cartridge and the rear housing, and a rear end configured to communicate with a front side space of the impeller.

In addition, the coolant flow path may be configured as a zigzag-type flow path including: a plurality of straight flow paths configured to deliver the coolant in a longitudinal direction of the housing; and a plurality of connection flow paths configured to alternately connect ends of the straight flow paths and ends of the adjacent straight flow paths.

Further, a front side end of the coolant flow path may be disposed adjacent to the front cartridge.

### Advantageous Effects

The air compressor of the present invention configured as described above uses a part of the compressed air as the secondary cooling air, thereby improving the performance in cooling the thrust bearing, the front and rear journal bearings, and the motor.

In addition, the secondary cooling air flows through the cartridge being in contact with the coolant, such that the cooling performance of the secondary cooling air may be improved, and the performance in cooling the bearing and the motor may be improved.

In addition, the coolant flow path is disposed adjacent to the air bearing support portion, and the cartridge being in contact with the coolant flow path provides a sufficient space for exchanging heat with the secondary cooling air, such that the cooling performance of the secondary cooling air may be improved, and the performance in cooling the bearing and the motor may be improved.

### DESCRIPTION OF DRAWINGS

FIG. 1 is a cross-sectional view of an air compressor according to an embodiment of the present invention.

FIG. 2 is a perspective view of a cooling flow path according to the embodiment of the present invention.

FIG. 3 is a cross-sectional perspective view illustrating a state in which a front housing and a cartridge according to the embodiment of the present invention are coupled.

FIG. 4 is a perspective view illustrating a shape of a cartridge according to the embodiment of the present invention and illustrating a flow path for cooling air flowing through the cartridge.

FIG. 5 is a cross-sectional view illustrating the air compressor having the flow path for the cooling air according to the embodiment of the present invention.

### DESCRIPTION OF REFERENCE NUMERALS

1000: Air compressor
100: Housing
110: Motor space
130: Coolant flow path
131: Coolant inlet port
133: Coolant discharge port
200: Front housing
250: Disc
300: Impeller housing
310: Air inlet port
330: Air discharge port
400: Impeller
401: First flow path
500: Rear housing
600: Motor
650: Motor shaft
710: Front journal bearing
720: Rear journal bearing
730: Front thrust bearing
740: Rear thrust bearing
750: Piston
800: Front cartridge
801: First space
802: Second space
803: Third space
804: Fourth space
810: Ring-shaped protrusion
815: Through-groove
820: O-ring groove
830: Second flow path
840: Third flow path
850: Pin groove
900: Rear cartridge
910: Fourth flow path
Path 1: First path
Path 2: Second path

### MODE FOR INVENTION

Hereinafter, the present invention will be described in more detail with reference to the drawings. The following embodiments are presented as examples for sufficiently providing the spirit of the present invention to those skilled in the art to which the present invention pertains. The present invention is not limited to the exemplary embodiments described below and may be specified as other aspects.

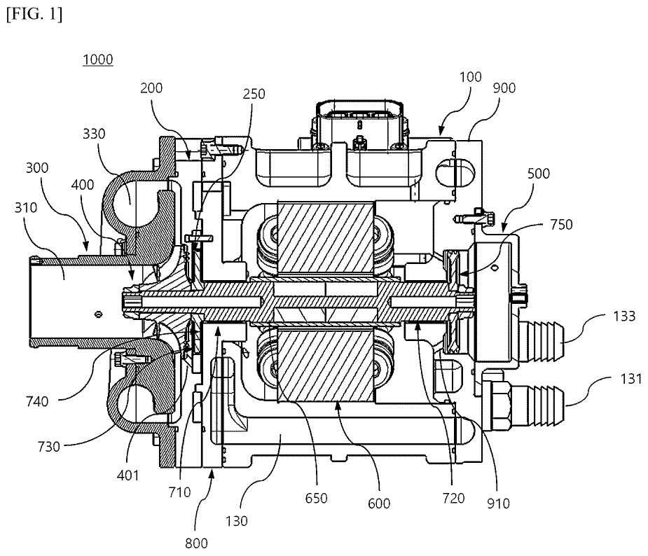

(For convenience, a side of an impeller is defined and described as a front side, and a side of a rear housing is defined and described as a rear side.) FIG. 1 is a cross-sectional view illustrating an air compressor 1000 according to an embodiment of the present invention. As illustrated, the air compressor 1000 of the present invention includes a housing 100 configured to accommodate a motor 600 and define an external appearance, a front housing 200 and an impeller housing 300 coupled to a front side of the housing 100 and configured to support an impeller 400 configured to suck air, a front cartridge 800 to which a front side of a motor shaft 650 is fixed, the front cartridge 800 being configured to cover a front open side of the housing 100, a rear cartridge 900 to which a rear side of the motor shaft 650 is fixed, the rear cartridge 900 being configured to cover a rear open side of the housing 100, a rear housing 500 coupled to a rear side of the rear cartridge 900, and the motor 600 installed in the housing 100 and configured to rotate the impeller 400.

An air inlet port 310, into which outside air is introduced, is formed at a front center of the impeller housing 300, and air discharge ports 330 are formed at two opposite front sides. The impeller 400 is installed in the impeller housing 300, and the motor shaft 650 of the motor 600 is coupled to a hollow portion formed through the impeller 400. That is, the impeller 400 is supported by the motor shaft 650. The air, which is sucked through the air inlet port 310 by a rotation of the impeller 400, is compressed and discharged to the air discharge port 330.

The front cartridge 800 is coupled to a rear side of the front housing 200 and supports a front journal bearing 710 configured to allow the motor shaft 650 to smoothly rotate forward. In addition, the front cartridge 800 is configured to define a cooling air flow path together with the front housing 200 and introduce a part of the air, which is introduced through the air inlet port 310, into the housing 100 so that the air is used as cooling air for cooling the bearings 710, 720, 730, and 740 and the motor 600. The detailed description of this configuration will be described below with reference to the drawings.

The rear housing 500 is coupled to a rear side of the housing 100 and blocks the motor shaft 650 so that the motor shaft 650 is not exposed to the outside. The rear housing 500 supports an end of the motor shaft 650. The rear cartridge 900 is provided inside the rear housing 500 and supports a rear journal bearing 720 to be described below.

The motor 600 includes the motor shaft 650 installed adjacent to an inner peripheral surface of the housing 100 and configured to rotate the impeller 400. The motor shaft 650 is a hollow shaft in which a hollow portion is penetratively formed in a longitudinal direction.

In a state in which one end of the motor shaft 650 is coupled to the hollow portion of the impeller 400, the motor shaft 650 is rotatably supported by the front journal bearing 710, which is installed on the front cartridge 800 positioned rearward of the impeller 400, and the rear journal bearing 720 installed on the rear cartridge 900.

In addition, a disc 250 is provided at a front side end of the motor shaft 650. A front thrust bearing 730 is provided between a front side of the disc 250 and the front housing 200 and supports an axial load of the front side of the disc 250. A rear thrust bearing 740 is provided between a rear side of the disc 250 and the front cartridge 800 and supports an axial load of the rear side of the disc 250. That is, the pair of thrust bearings 730 and 740 are provided at the front and rear sides of the disc 250 and support the disc 250 so that the disc 250 is rotatable.

In addition, a piston 750 may be disposed at a rear side end of the motor shaft 650 and reduce thrust when the impeller 400 rotates.

According to the air compressor 1000 configured as described above, when the motor 600 operates by receiving electric power from the outside, the motor shaft 650 rotates the impeller 400 while rotating, the outside air is introduced through the air inlet port 310 and compressed while flowing along the impeller 400, and then the compressed air is discharged to the air discharge port 330.

In this case, the disc 250 coupled to the motor shaft 650 may be provided at a front side of the motor shaft 650. More specifically, the disc 250 may be disposed between the front housing 200 and the front cartridge 800. The disc 250 is disposed at the front side of the motor shaft 650 as described above, which may improve aerodynamic efficiency. The disc 250 supports the thrust generated when the impeller 400 rotates. In case that the disc 250 is disposed at the front side of the motor shaft 650, a clearance, which is caused by an axial thermal growth of a rotor caused by internal heat during a high-speed rotation, may be minimized, thereby improving aerodynamic efficiency.

Meanwhile, according to the air compressor 1000, in order to remove heat generated while the motor 600 operates, a coolant flow path 130, through which a coolant for exchanging heat with the motor 600 flows, is provided on the housing 100. Therefore, the housing 100 may have a predetermined thickness because the housing 100 needs to accommodate the coolant therein. Therefore, the coolant is accommodated in an accommodation space formed between a cylindrical outer peripheral surface and an inner peripheral surface of the housing 100. A coolant inlet port 131 for supplying the coolant to the coolant flow path 130 and a coolant discharge port 133 for discharging the coolant, which has exchanged heat, may be formed on the rear housing 500.

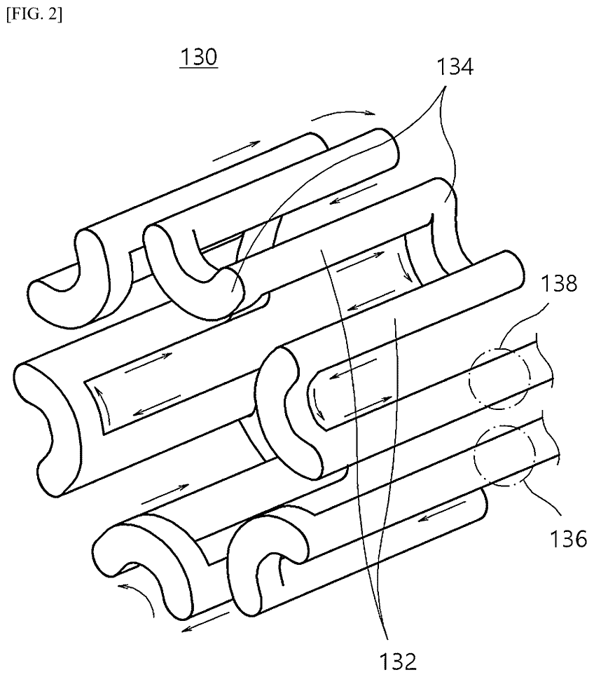

FIG. 2 is a perspective view illustrating the coolant flow path 130 according to the embodiment of the present invention. As illustrated, the coolant flow path 130 has an introduction part 136 configured to communicate with the coolant inlet port 131 so that the coolant is introduced into the introduction part 136, and a discharge part 138 configured to communicate with the coolant discharge port 133 so that the coolant is discharged through the discharge part 138. The coolant is introduced into the coolant flow path 130 through the introduction part 136 and circulated. The coolant cools the bearings 710, 720, 730, and 740 and the motor 600 around the coolant flow path 130 and then is discharged to the outside of the coolant flow path 130 through the discharge part 138. The introduction part 136 and the discharge part 138 may be provided at one side of the rear side of the housing 100 and connected to the outside of the housing 100.

The coolant introduced into the coolant flow path 130 through the introduction part 136 circulates along the coolant flow path 130. As illustrated, the coolant flow path 130 is configured in a zigzag shape along a periphery of the housing 100. One coolant flow path 130 is formed as straight flow paths 132 formed in a longitudinal direction of the housing 100 communicate with connection flow paths 134 connected to the adjacent straight flow paths 132 at two opposite longitudinal ends of the straight flow path 132. In accordance with the disposition of the peripheral components, the connection flow path 134, which connects the straight flow paths 132, may be implemented in a curved shape concave in a direction toward the motor shaft 650, implemented in a curved shape convex toward the outer peripheral surface of the housing 100, or implemented in a straight shape. In the present embodiment, an example will be described in which the connection flow path 134 has a concave shape.

As described above, the coolant circulates while surrounding the entire housing 100 while flowing in a zigzag manner along the coolant flow path 130, such that a cooling area increases. Therefore, it is possible to evenly cool the motor 600 as well as the bearings 710, 720, 730, and 740.

The air compressor 1000 of the present invention is characterized by further improving performance in cooling the bearings 710, 720, 730, and 740 and the motor 600 by forming the cooling air flow path for introducing air into the housing 100 in addition to the coolant flow path 130 so that a part of the air in the air inlet port 310 is used as the cooling air. In particular, the air compressor 1000 of the present invention is additionally characterized in that the cooling air flow path is configured to pass along the front cartridge 800 and the rear cartridge 900 that are disposed to be close to the coolant flow path 130, such that the cooling air exchanges heat with the coolant, thereby further improving the cooling performance of the cooling air. Hereinafter, the cooling air flow path will be described in detail with reference to the drawings.

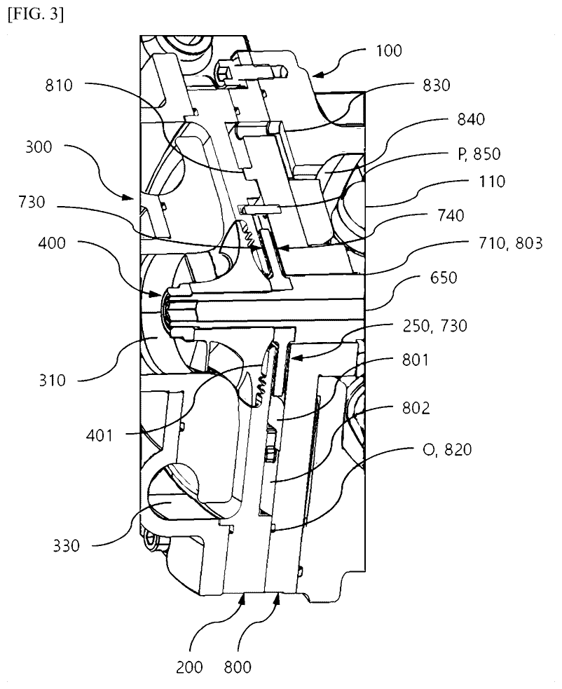

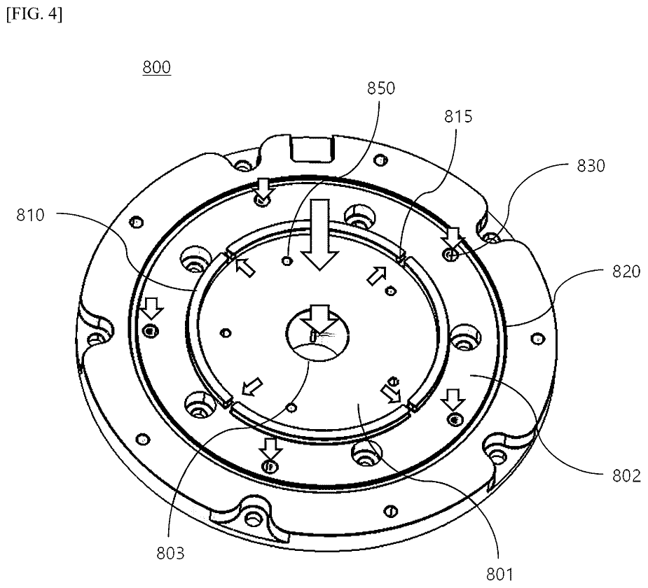

FIG. 3 is a cross-sectional perspective view illustrating a state in which the front housing 200 and the front cartridge 800 according to the embodiment of the present invention are coupled, and FIG. 4 is a perspective view illustrating a shape of the front cartridge 800 according to the embodiment of the present invention and the front cartridge 800 having the flow path for the cooling air flowing through the front cartridge 800.

As illustrated, the cooling air flow path includes cooling air spaces 801, 802, and 803 formed between the front housing 200 and the front cartridge 800. The cooling air spaces 801, 802, and 803 may include a first space 801 formed radially inside the front cartridge 800, a second space 802 formed radially outward, and a third space 803 formed through a center of the front cartridge 800. The first space 801 and the second space 802 may be separated by a ring-shaped protrusion 810 protruding forward from a front surface of the front cartridge 800, and the first space 801 and the second space 802 may communicate with each other through through-grooves 815 formed in the ring-shaped protrusion 810. The through-grooves 815 may be provided as a plurality of through-grooves 815 radially disposed in a circumferential direction of the ring-shaped protrusion 810. The ring-shaped protrusion 810 maintains concentricity when the front housing 200 and the front cartridge 800 are assembled, and a flow rate of secondary cooling air may be changed by adjusting the number and sizes of the through-grooves 815 in the ring-shaped protrusion 810.

In addition, the third space 803 may be formed between the front cartridge 800 and the front journal bearing 710 for implementing a smooth rotation of the motor shaft 650 and configured such that the cooling air passing through the third space 803 may directly cool the front journal bearing 710.

In addition, a radially outer side of the second space 802 may be sealed by an O-ring O provided between the front housing 200 and the front cartridge 800. The O-ring O may be accommodated in an O-ring groove 820 recessed rearward from a radially outer periphery of the front cartridge 800.

Meanwhile, the cooling air flow path includes a first flow path 401 formed between the impeller 400 and the front housing 200 to introduce a part of air in the air inlet port 310 into the first space 801. The first flow path 401 is configured to pass along the front thrust bearing 730.

As described above, the air in the first space 801 is introduced into the second space 802 through the through-groove 815. In order to introduce the cooling air in the second space 802 into a motor space 110 in the housing 100, the cooling air flow path includes a second flow path 830 formed through the front cartridge 800 in the second space 802, and a third flow path 840 formed through the housing 100.

In addition, the disc 250 may be provided between the front side of the motor shaft 650 and the impeller 400 connected to the end of the motor shaft 650. The front thrust bearing 730 is provided between the disc 250 and the front housing 200, and the rear thrust bearing 740 is provided between the disc 250 and the front cartridge 800.

In this case, the cooling air introduced into the first flow path 401 may be introduced into the first space 801 via the front thrust bearing 730 and directly cool the front thrust bearing 730. In addition, the cooling air introduced into the first space 801 may be introduced into the third space 803 via the rear thrust bearing 740 and directly cool the rear thrust bearing 740.

Pin grooves 850 may be formed in the first space 801 of the front cartridge 800 so that pins P, which each have a front end fixed to the front housing 200 and the other end fixed to the front cartridge 800, are inserted into the pin grooves 850. The pin grooves 850 may be provided as a plurality of pin grooves 850 radially formed in the circumferential direction of the front cartridge 800.

With reference to FIG. 4, with the above-mentioned configuration, when the cooling air is introduced into the first flow path 401, the cooling air is delivered to the first space 801, and the cooling air of the first space 801 is cooled while exchanging heat with the front cartridge 800 and then move to the third space 803 or move to the second space 802 through the through-groove 815. The cooling air moved to the second space 802 is cooled while exchanging heat with the front cartridge 800 and then supplied to the motor space 110 through the second and third flow paths 830 and 840, such that the cooling air cools the motor 600. The cooling air moved to the third space 803 flows along the front journal bearing 710 and then moves rearward along the motor shaft 650.

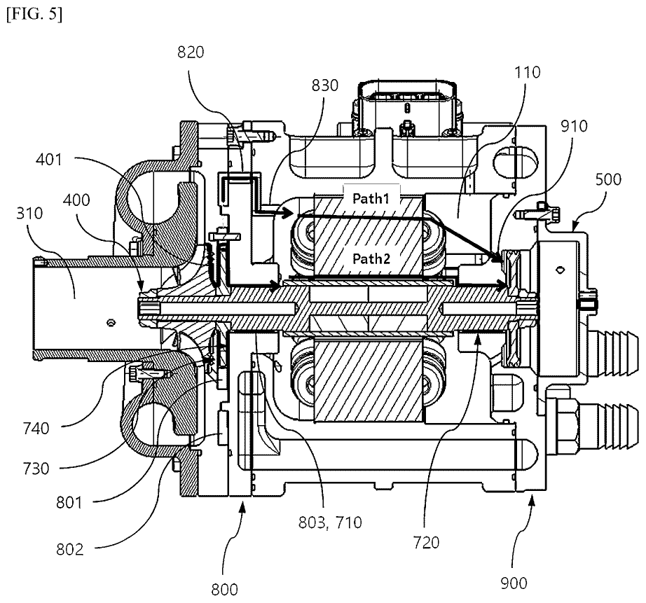

FIG. 5 is a cross-sectional view illustrating the air compressor 1000 having the cooling air flow path according to the embodiment of the present invention.

As illustrated, the cooling air flow path includes a first path Path 1 and a second path Path 2. The first path Path 1 includes the first flow path 401 configured to introduce a part of the air in the air inlet port 310 into the first space 801 of the front cartridge 800. The air supplied to the first flow path 401 cools the front thrust bearing 730 while flowing along the front thrust bearing 730. In addition, in order to cool the cooling air through the front cartridge 800, the first path Path 1 includes the first and second spaces 801 and 802 formed in the front cartridge 800, more specifically, formed between the front cartridge 800 and the front housing 200. In addition, the first path Path 1 includes the second and third flow paths 830 and 840 configured to supply the cooling air in the second space 802 to the motor space 110. The cooling air supplied to the motor space 110 cools the motor 600 while being simultaneously cooled while exchanging heat with the coolant flow path. In addition, the first path Path 1 includes a fourth flow path 910 formed through the rear cartridge 900 to supply the cooling air in the motor space 110 to a rear end of the rear cartridge 900. The cooling air, which is introduced between the rear cartridge 900 and the rear housing 500 through the fourth flow path 910, circulates to the front side of the impeller 400 through a cooling air circulation flow path (not illustrated) having a front end configured to communicate with a space between the rear cartridge 900 and the rear housing 500, and a rear end configured to communicate with the air inlet port 310.

The second path Path 2 includes the first flow path 401 configured to introduce a part of the air in the air inlet port 310 into the first space 801 of the front cartridge 800. The air supplied to the first flow path 401 cools the front thrust bearing 730 while flowing along the front thrust bearing 730. In addition, in order to cool the cooling air through the front cartridge 800, the second path Path 2 includes the first space 801 formed in the front cartridge 800, more specifically, formed between the front cartridge 800 and the front housing 200. The second path Path 2 includes the third space 803 configured to supply the cooling air in the first space 801 to the front journal bearing 710. In this case, the second path Path 2 is configured to pass along the rear thrust bearing 740 to cool the rear thrust bearing 740. The cooling air supplied to the third space 803 flows along the front journal bearing 710 and cools the front journal bearing 710. In addition, the second path Path 2 includes a fourth space 804 between an outer peripheral surface of the motor shaft 650 and the motor 600, so that the cooling air flows through the fourth space 804 and cools the motor shaft 650. The cooling air flowing through the fourth space 804 flows along the rear journal bearing 720 and cools the rear journal bearing 720. The cooling air flowing along the rear journal bearing 720 is introduced between the rear cartridge 900 and the rear housing 500 and then circulates to the front side of the impeller 400 through the cooling air circulation flow path (not illustrated).

The technical spirit should not be construed as being limited to the embodiments of the present invention. Of course, the scope of application is diverse, and various modifications and implementations may be made by those skilled in the art without departing from the subject matter of the present invention claimed in the claims. Accordingly, these improvements and modifications will fall within the scope of the present invention as long as they are apparent to those skilled in the art.

1. An air compressor comprising:
a housing configured to accommodate a motor having a motor shaft, the housing having a coolant flow path formed between a cylindrical inner peripheral surface and an outer peripheral surface so that a coolant flows along the coolant flow path;
a front housing coupled to a front side of the housing and configured to support an impeller configured to suck outside air;
a front cartridge configured to accommodate a front journal bearing and configured to support a front side of the motor shaft by means of the front journal bearing;
a rear cartridge configured to accommodate a rear journal bearing and configured to support a rear side of the motor shaft by means of the rear journal bearing;
a rear housing coupled to a rear side of the housing and configured to seal the rear side of the housing; and
a cooling air flow path configured to cool the motor shaft or the motor by receiving a part of air introduced from a front side of the impeller and introducing the air into the housing,
wherein the cooling air flow path comprises a cooling air space formed between the front housing and the front cartridge.

2. The air compressor of claim 1, wherein the cooling air flow path passes along the front journal bearing and the rear journal bearing.

3. The air compressor of claim 2, wherein the cooling air flow path comprises:
a first flow path formed between the impeller and the front housing to supply a part of the air, which is introduced into the impeller, to the cooling air space;
a second flow path formed through the front cartridge to introduce the air in the cooling air space into a motor space in the housing; and
a third flow path formed in the housing and configured to allow the second flow path and the motor space to communicate with each other.

4. The air compressor of claim 3, wherein the air compressor comprises a disc provided on the motor shaft, and
wherein the disc is disposed between the front housing and the front cartridge.

5. The air compressor of claim 4, wherein a front side of the disc is rotatably supported by a front thrust bearing provided between the disc and the front housing,
wherein a rear side of the disc is rotatably supported by a rear thrust bearing provided between the disc and the front cartridge, and
wherein cooling air introduced into the first flow path is introduced into the cooling air space via the front thrust bearing and the rear thrust bearing to cool the front thrust bearing and the rear thrust bearing.

6. The air compressor of claim 3, wherein the cooling air space comprises:
a first space formed radially inside a front surface of the front cartridge; and
a second space formed radially outward,
wherein the front cartridge comprises:
a ring-shaped protrusion protruding forward in a circumferential direction from the front surface of the front cartridge to separate the first space and the second space; and
a through-groove recessed rearward at a front side end of the ring-shaped protrusion to allow the first space and the second space to communicate with each other,
wherein the first space communicates with the first flow path, and
wherein the second space communicates with the second flow path.

7. The air compressor of claim 6, wherein the cooling air space comprises a third space configured to communicate with the first space and formed between the motor shaft and a shaft through-hole penetrated by the motor shaft, and
wherein the front journal bearing is provided in the third space so that the front journal bearing is cooled by the air.

8. The air compressor of claim 2, wherein a radially outer side of the cooling air space is sealed by an O-ring provided between the front housing and a radially outer side of the front cartridge.

9. The air compressor of claim 6, wherein the through-groove is provided as a plurality of through-grooves disposed to be spaced apart from one another in a circumferential direction of the ring-shaped protrusion,
wherein the second flow path is provided as a plurality of second flow paths disposed to be radially spaced apart from one another in a circumferential direction of the front cartridge, and
wherein the second flow path is disposed on a radially outward extension line of the through-groove.

10. The air compressor of claim 6, wherein a pin groove is formed in the first space so that a pin P, which has a front end fixed to the front housing and the other end fixed to the front cartridge, is inserted into the pin groove, and
wherein the pin groove is provided as a plurality of pin grooves radially formed in a circumferential direction of the front cartridge.

11. The air compressor of claim 5, wherein the cooling air flow path comprises a first path and a second path, and
wherein the first path passes along the first flow path, the first and second spaces, the second and third flow paths, the motor space, the motor, and a fourth flow path formed through the rear cartridge.

12. The air compressor of claim 10, wherein the second path passes along the first flow path, the front thrust bearing, the first space, the rear thrust bearing, the third space, the front journal bearing, a fourth space between an outer peripheral surface of the motor shaft and the motor, and the rear journal bearing.

13. The air compressor of claim 12, wherein the air passing through the first path or the second path circulates to a front side of the air compressor through a cooling air circulation flow path having a front end configured to communicate with a space between the rear cartridge and the rear housing, and a rear end configured to communicate with a front side space of the impeller.

14. The air compressor of claim 1, wherein the coolant flow path is configured as a zigzag-type flow path including:
a plurality of straight flow paths configured to deliver the coolant in a longitudinal direction of the housing; and
a plurality of connection flow paths configured to alternately connect ends of the straight flow paths and ends of the adjacent straight flow paths.

15. The air compressor of claim 14, wherein a front side end of the coolant flow path is disposed adjacent to the front cartridge.
